(19) United States
(12) Patent Application Publication
(10) Pub. No.: US 2026/0367968 A1
(43) Pub. Date: Nov. 19, 2026

(54) ADAPTIVE TASK MANAGEMENT FRAMEWORK

(71) Applicant: Cisco Technology, Inc., San Jose, CA (US)

(72) Inventors: Viktor Mats Emanuel Leijon, San Jose, CA (US); Sahithi Patibandla, Newark, CA (US)

(21) Appl. No.: 19/412,121

(22) Filed: Dec. 8, 2025

Related U.S. Application Data
(60) Provisional application No. 63/807,219, filed on May 16, 2025.

(51) Int. Cl. G06F 9/48

(52) U.S. Cl. CPC G06F 9/4881; G06F 2209/486

(57) ABSTRACT

Techniques for adaptive task management that enable dynamic coordination and collaboration between collaboration between artificial intelligence agents, rule-based computer programs, and human actors in executing complex, long-running workflows. A task management system stores tasks in a task queue, where a particular task includes a precondition defining activation logic, a substance defining execution logic, and a postcondition defining subsequent task generation logic. The system evaluates the activation logic to determine that the particular task is unblocked for execution, selects a particular execution method from a group of execution methods to execute the execution logic of the particular task, and receives an execution result of the particular task by the particular execution method. The system evaluates the execution result and the subsequent task generation logic of the postcondition to determine one or more new tasks, and adds the one or more new tasks to the task queue for subsequent processing.

### RELATED APPLICATIONS

This application claims priority to U.S. Provisional Patent Application No. 63/807,219, filed May 16, 2025, the entire contents of which are incorporated herein by reference.

### TECHNICAL FIELD

The present disclosure relates generally to adaptive task management systems that enable dynamic coordination and collaboration between artificial intelligence agents, rule-based computer programs, and human actors in executing complex, long-running workflows through intelligent task decomposition and condition-based activation.

### BACKGROUND

Modern computing environments increasingly rely on automated systems to manage complex workflows that span extended periods and involve multiple participants. These systems typically decompose high-level objectives into discrete tasks, coordinate the execution of those tasks across various computational resources, and manage dependencies between different workflow components. Traditional workflow management approaches often employ centralized orchestration models where a single controller maintains complete oversight of task sequences, resource allocation, and execution monitoring throughout the entire process lifecycle.

However, conventional workflow systems face substantial limitations when dealing with dynamic, long-running processes that require adaptive coordination between different types of actors. Many existing systems rely on predetermined task sequences and static resource allocation strategies, making them poorly suited for scenarios where requirements evolve during execution or where human intervention becomes necessary at unpredictable intervals. Additionally, these systems often struggle to effectively integrate artificial intelligence capabilities with human decision-making processes, typically treating AI agents and human participants as separate entities rather than collaborative partners in a unified workflow ecosystem.

Furthermore, current workflow management solutions frequently lack the flexibility to handle tasks that may remain dormant for extended periods before activation conditions are met, or to dynamically adjust task priorities and execution strategies based on real-time performance feedback. The rigid architectural constraints of existing systems make it challenging to accommodate scenarios where task decomposition and planning decisions must be distributed across multiple intelligent agents rather than centralized in a single orchestrator. These limitations become particularly problematic in complex operational environments where workflows must adapt to changing conditions, incorporate diverse expertise from both human, rule-based, and artificial intelligence sources, and maintain coherent progress toward long-term objectives despite unpredictable interruptions and evolving requirements.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a task management framework that includes a task management system that processes tasks using various execution methods including human-in-the-loop, artificial intelligence, and rule-based approaches.

FIG. 2 illustrates a component diagram showing task components associated with a task, where the components include pre-conditions defining activation logic, substance defining execution logic, post-conditions defining subsequent task generation logic, priority for execution ordering, and metadata for task routing and access control.

FIG. 3A illustrates a directed acyclic graph diagram showing interconnections between various tasks and their execution flow, including gather user intent, system setup, identify device driver, create package, create template, and create data model tasks.

FIGS. 3B and 3C illustrate flowcharts depicting task decomposition and execution processes, where FIG. 3B shows a create package process with package generation conversation steps, and FIG. 3C depicts system tasks divided into task groups with deterministic code and language model generated steps.

FIG. 4 illustrates a system package wizard that includes a task execution engine containing a directed acyclic graph, user tasks, and system tasks, where the engine receives user interaction from and provides display content to an integrated development environment.

FIG. 5A illustrates a system architecture showing interactions between components of the task management system, including a wizard interface with configuration dialog for system service package configuration and a progress indicator for package building status.

FIG. 5B illustrates a system diagram showing interactions between components of an integrated development environment system, where the environment displays multiple confirmation interfaces for packet, driver, template, and yang file confirmation steps.

FIG. 5C illustrates a system diagram showing communication between components of an integrated development environment, where the environment includes service code and service payload interfaces for displaying and confirming service-related information.

FIG. 6 illustrates a flowchart of a method for task management that involves storing tasks in a task queue, evaluating activation logic, selecting execution methods, receiving execution results, and generating new tasks based on postcondition logic.

FIG. 7 illustrates a flowchart of a method for managing tasks that involves managing a persistent task graph with interconnected tasks, evaluating activation logic, coordinating execution across multiple methods, and maintaining task persistence across extended time periods.

FIG. 8 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to adaptive task management systems that enable dynamic coordination and collaboration between artificial intelligence agents, rule-based computer programs, and human actors in executing complex, long-running workflows through intelligent task decomposition and condition-based activation.

A first method described herein includes storing a plurality of tasks in a task queue of the task management system where a particular task of the plurality of tasks includes a precondition defining activation logic, a substance defining execution logic, and a postcondition defining subsequent task generation logic. The first method may further include evaluating the activation logic to determine that the particular task is unblocked for execution, and selecting, from a group of execution methods, a particular execution method to execute the execution logic of the particular task. Additionally, the first method may include receiving an execution result of the particular task by the particular execution method, and evaluating the execution result and the subsequent task generation logic of the postcondition to determine one or more new tasks. Further, the first method may include adding the one or more new tasks to the task queue for subsequent processing.

A second method described herein includes managing a persistent task graph comprising tasks that are interconnected, each task having embedded intelligence for decomposition and execution coordination. Further, the second method may include evaluating activation logic included in embedded intelligence for the tasks within the task graph, and coordinating execution of the tasks across multiple execution methods. Additionally, the second method may include generating new tasks based on execution results through postcondition logic included in the embedded intelligence of the tasks, and maintaining task persistence across extended time periods while allowing dynamic modification of task relationships and priorities in the persistent task graph.

Additionally, the techniques of at least the first method and the second method, and any other techniques described herein, may be performed by a system and/or device having non-transitory computer-readable media storing computer-executable instructions that, when executed by one or more processors, performs the method(s) described above.

### EXAMPLE EMBODIMENTS

Traditional workflow systems rely on centralized planning and rigid task sequences that cannot adapt to evolving requirements in long-running collaborative projects. These conventional approaches face limitations when managing complex tasks that span days or months, require multiple actors with different capabilities, and encounter unexpected conditions during execution. Centralized orchestrators become bottlenecks when plans need modification, and static task definitions cannot accommodate the dynamic nature of real-world collaborative work environments.

This disclosure describes an adaptive task management framework that addresses these limitations by enabling dynamic coordination between artificial intelligence agents, rule-based computer programs, and human participants through a decentralized task intelligence architecture. The framework allows tasks to remain dormant until specific activation conditions are met, eliminating the need for continuous polling or rigid scheduling mechanisms. Tasks autonomously decompose into subtasks based on embedded logic and generate new tasks based on real-time execution results, creating an evolving task graph that adapts to changing circumstances.

The task management system supports cybernetic cooperation between humans and artificial intelligence agents for collaborative task solving. Each task contains embedded intelligence that defines activation logic, execution methods, and subsequent task generation rules. The system coordinates execution across heterogeneous actors, including human participants, artificial intelligence models, and rule-based systems, while maintaining persistent task relationships over extended time periods. This approach enables seamless handoffs between different types of intelligence and supports complex, long-running projects where requirements evolve organically based on execution outcomes and real-world conditions.

The framework operates on the principle that tasks themselves generate new tasks, treating tasks not as fixed sequences but as dynamic entities that decompose, spawn, and adapt based on execution outcomes. This approach enables cybernetic cooperation between humans and artificial intelligence agents for collaborative task solving across extended time periods. The framework architecture centers on a persistent task graph comprising tasks that are interconnected, with each task having embedded intelligence for decomposition and execution coordination. Unlike traditional systems where intelligence resides in a central orchestrator, the adaptive framework distributes intelligence throughout individual tasks. Each task contains the logic for planning, decomposition, and execution within the task structure itself. When a task executes, the outcome extends beyond simple state changes to include the generation of entirely new tasks that are added to the system for subsequent processing.

The anatomy of tasks within the framework includes five components that work together to enable autonomous operation: precondition, substance, postcondition, priority, and metadata. The precondition defines activation logic that determines when a task becomes ready for execution. The precondition operates as a dynamic gate that the system continuously evaluates across all dormant tasks. Preconditions range from simple temporal conditions, such as time-based triggers, to complex natural language conditions that delegate decision-making to a language model or human evaluator. For example, a precondition might specify that a task remains dormant until a specific date is reached, or the precondition might require human judgment about whether certain quality criteria have been met before the task becomes eligible for execution.

The substance defines execution logic that specifies how a task performs its designated work. The substance supports multiple execution modalities to accommodate different types of work. Script execution allows tasks to run executable programs directly within the system. Human-directed questions enable tasks to request input or decision-making from human participants through structured interfaces. AI-driven processing delegates task execution to language models or other artificial intelligence agents that can perform reasoning, analysis, or generation activities. This flexibility in execution methods allows the same framework to coordinate work across heterogeneous actors seamlessly.

The postcondition defines subsequent task generation logic that determines what happens after task execution completes. The postcondition operates as an executable function that takes the output of the task's substance as input and returns a list of new, fully-formed task objects to be injected into the system's global queue. This generative capability enables emergent planning where the overall plan evolves from real-world outcomes of individual task executions rather than being constrained by pre-conceived structures. The postcondition logic supports rule-based generation for predictable follow-up tasks, template-based instantiation for consistent patterns, and AI-driven generation for adaptive responses to unexpected outcomes.

The priority enables tasks to specify their relative importance for execution ordering. When multiple tasks have their preconditions satisfied simultaneously, the system uses priority values to determine execution sequence. Priority assignment considers factors such as deadline urgency, resource dependencies, and strategic importance to the overall goal. The priority system supports dynamic adjustment as project conditions change, allowing tasks to increase or decrease in priority based on evolving circumstances.

The metadata defines assignment logic for routing tasks to appropriate execution methods and provide access control permissions and execution method availability constraints for task assignment optimization. The metadata includes expertise requirements that specify what capabilities are needed to execute a task successfully. Cost efficiency metrics help the system select the most economical execution method when multiple options are available. Risk assessment parameters guide the system toward execution methods that minimize potential negative outcomes for tasks. Access control permissions ensure that sensitive tasks are routed only to authorized actors, while availability constraints prevent task assignment to execution methods that are currently unavailable or overloaded.

The framework operates through continuous dynamic evaluation and activation of tasks within the persistent task graph. The system maintains a global queue that constantly re-evaluates task readiness by checking preconditions against current system state. This evaluation process enables tasks to remain dormant for extended periods such as days or months before their preconditions are met, supporting long-running projects that span significant time horizons. When evaluation determines that a particular task is unblocked for execution, the task becomes eligible for processing according to its priority relative to other ready tasks.

Task selection and execution method assignment occur through analysis of task metadata and current system capabilities. The task management system examines the group of execution methods available, which includes artificial intelligence agents, human participants, and rule-based computer programs. The selection process determines the appropriate execution method by matching task requirements with execution method capabilities. For artificial intelligence agents, the system considers different types such as reasoning models for complex tasks and simpler models for faster identification tasks. Human participants are selected when tasks require creativity, judgment, or domain expertise that exceeds current AI capabilities. Rule-based computer programs handle deterministic processing where consistent, predictable outcomes are desired.

Consider an illustrative example where a network engineer needs to create a network system package for segment routing traffic engineering. The engineer initiates the process by providing device configuration information to an AI coding agent integrated within the adaptive task management framework. The task management system creates a top-level task labeled "Generate Network System Package" that includes embedded decomposition logic and an execution mechanism appropriate for the required work. This top-level task immediately begins autonomously decomposing the project into necessary subtasks based on the provided configuration information.

The decomposition process generates multiple interconnected tasks with specific dependencies and execution requirements. A "Generate Network System Template" task emerges as a rule-based subtask that requires device configuration as input and produces a template blueprint for the network system package using predefined code execution. Simultaneously, a "Generate YANG Models" task is created as an AI-driven subtask that invokes a language model to produce initial YANG data model definitions based on the user input and content generated by previous tasks. This task contains embedded execution methods for AI generation of code artifacts and proceeds without direct intervention from the task management system.

The YANG generation task demonstrates the framework's ability to handle complex, multi-stage processing. The task decomposes into additional validation subtasks that verify the generated YANG model correctness. A "Validate YANG Models with User" task emerges as a human-in-the-loop subtask where the system prompts the user to review and validate the AI-generated YANG model files through a wizard interface. This task waits for user feedback and includes logic to interpret the user's input or approval as a condition for completion, ensuring correctness and alignment with user expectations.

Upon successful YANG model validation, the postcondition logic generates a "Generate SYSTEM Service Code" task configured to execute after validation completion. This code-generation subtask produces the necessary service implementation code, such as Python or XML code modules, for the SYSTEM package. The task uses either an AI component or predefined code templates to assemble the final service code once the YANG models are confirmed. Throughout this process, progress indicators show the status of task execution to users, providing visibility into the complex multi-step workflow.

Execution and result collection occur through coordination across multiple execution methods while maintaining centralized monitoring. The task management system supports distributed execution of tasks while ensuring that results are gathered into a central point for coordination and decision-making. When an execution method completes a task, the system receives an execution result that includes both the direct output of the task and any contextual information needed for subsequent processing. This result collection process maintains shared memory that provides global context accessible to all tasks in the system, enabling tasks to build upon previous work and maintain consistency across the entire workflow.

Postcondition logic and emergent task generation represent aspects of the framework. After receiving an execution result, the task management system evaluates the result along with the subsequent task generation logic of the postcondition to determine new tasks. This evaluation process is performed by a language-model-based agent when adaptive reasoning is required, or through rule-based processing when deterministic outcomes are appropriate. The postcondition logic analyzes execution outcomes and generates entirely new, unforeseen tasks that address discovered requirements, handle unexpected conditions, or capitalize on emergent opportunities.

In the network system package generation example, when the YANG validation task completes with user approval, the postcondition logic generates multiple follow-up tasks simultaneously. A "Generate Unit Tests" task is created to ensure code quality, while a "Package Assembly" task is generated to combine all components into a deployable system package. If the validation reveals issues, the postcondition logic instead generates debugging tasks and routes the workflow back to appropriate correction steps. This dynamic response capability enables the system to adapt to real-world conditions without requiring pre-planned contingency paths.

Task templates provide reusable task structures for consistent execution patterns across multiple workflow instances associated with the task management system. The templates define common task patterns that can be instantiated repeatedly, ensuring consistency while allowing for dynamic execution within established structures. Task templates may be created through artificial intelligence analysis of previously executed task patterns and stored with versioning metadata for template evolution tracking. This approach enables the system to learn from successful workflows and apply proven patterns to new situations while maintaining the flexibility to adapt when circumstances require deviation from standard approaches.

Priority-based queue management ensures efficient resource utilization and goal-oriented progress. The task management system maintains priorities usable to determine an execution order of tasks relative to each other, and coordinates execution of tasks across multiple execution methods by causing tasks to be executed according to the execution order. Priority calculation considers multiple factors including deadline constraints, resource availability, dependency relationships, and strategic importance. The task management system supports parallel execution of multiple unblocked tasks simultaneously when resources permit, maximizing throughput while respecting priority ordering and dependency constraints.

Heterogeneous actor collaboration enables seamless handoffs between different types of intelligence and capabilities. The task management system treats humans, AI agents, and rule-based systems as execution methods that execute tasks and create new ones. An AI agent might generate code that creates a task for human review, which in turn generates a task for a deterministic script to run validation tests. This seamless handoff between different types of intelligence occurs without requiring explicit coordination protocols, as the task structure itself contains the routing and handoff logic.

Support for long-running projects addresses a fundamental limitation of existing systems through task persistence across extended time periods while allowing dynamic modification of task relationships and priorities in the persistent task graph. Tasks remain dormant for months if necessary, automatically activating when their preconditions are satisfied. Project teams can hand off work between members, pause and resume projects, and adapt to changing requirements without losing progress or context. The persistent task graph maintains all relationships and dependencies while supporting dynamic modification as project needs evolve.

Central coordination provides the monitoring and orchestration capabilities needed for complex multi-actor workflows. The task management system includes a central monitor that tracks task states, evaluates preconditions, and coordinates task execution across distributed actors. This centralized monitoring ensures visibility into overall progress while allowing distributed execution of individual tasks. The central coordinator manages resource allocation, prevents conflicts between concurrent tasks, and maintains consistency across the entire workflow.

Dynamic re-planning capabilities enable the system to adapt to changing requirements and unexpected conditions. As tasks execute and generate new tasks through postcondition logic, the overall plan evolves organically. The task management system supports speculative evaluation where pure tasks are executed early and results discarded if predictions are wrong, enabling optimistic processing that accelerates workflow completion when predictions prove accurate. The framework distinguishes between pure tasks that cause no harmful state changes and state-changing tasks that must await certainty before execution.

Integration of AI and human creativity combines the strengths of artificial intelligence with human judgment and domain expertise. The system moves beyond simple approval gates found in traditional business process management tools, integrating human creativity and problem-solving directly into the automated, evolving planning process. Humans contribute not just as executors of predefined tasks but as active planners who can inject new tasks, modify priorities, and guide the overall direction of complex workflows.

The technical benefits of this adaptive task management framework include resilience to unexpected events, emergent planning capabilities, scalable collaboration across heterogeneous actors, and support for complex long-running projects. The framework enables organizations to tackle projects that would be impractical with traditional workflow systems, such as software development projects where themes break into epics that break into tasks in a hierarchical structure similar to software project management, but with the added capability for dynamic adaptation and multi-actor collaboration across extended time periods.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

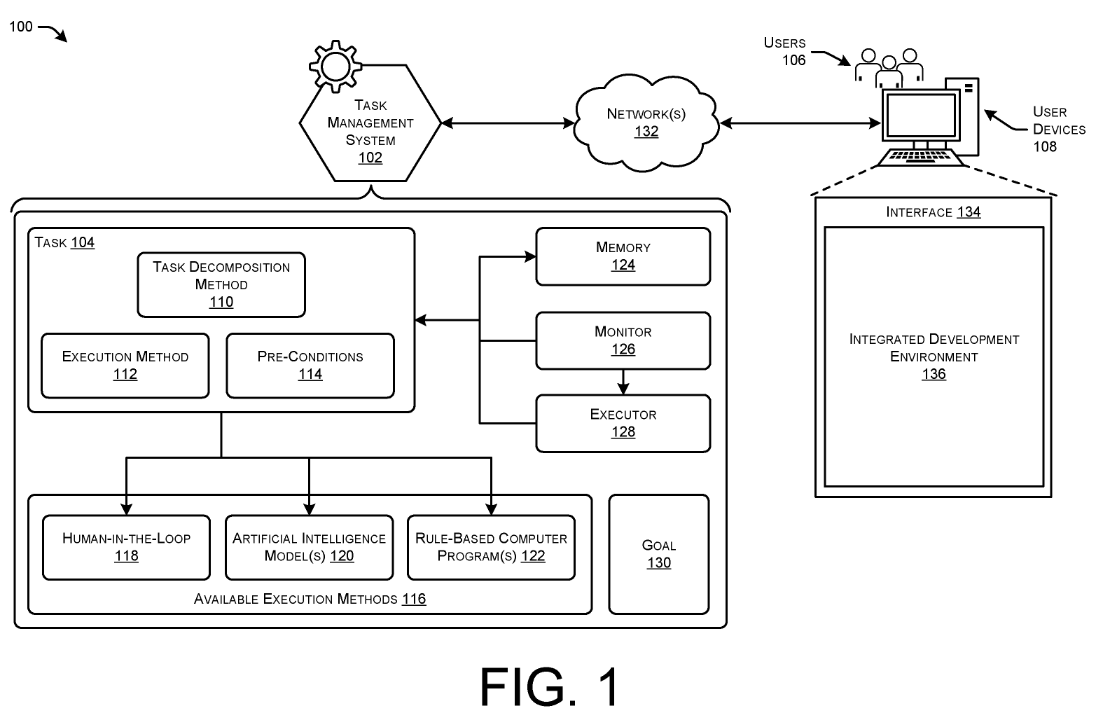

FIG. 1 illustrates a block diagram of a task management framework 100. The task management framework 100 includes a task management system 102 connected through a network 132 to user devices 108 operated by users 106. The task management system 102 includes a task 104 having a task decomposition method 110, an execution method 112, and pre-conditions 114. The task management system 102 includes available execution methods 116 comprising a human-in-the-loop method 118, an artificial intelligence model 120, and a rule-based computer program 122. The system also includes memory 124, a monitor 126, an executor 128, and a goal 130. The user devices 108 include an interface 134 containing an integrated development environment 136. The interface 134 enables interaction between the users 106 and the task management system 102 through the network 132. The task management system 102 processes tasks through the task decomposition method 110, which works in conjunction with the execution method 112 and pre-conditions 114. The monitor 126 oversees task execution while the executor 128 implements tasks using the available execution methods 116. The memory 124 stores task-related data, and the goal 130 defines the desired outcome for task execution.

The task management framework 100 provides a comprehensive system for managing complex, long-running tasks that require coordination between multiple actors. The task management system 102 operates as a centralized orchestrator that maintains a task queue containing a plurality of tasks. Each task 104 within the plurality of tasks includes structured components that enable autonomous operation and dynamic adaptation. The task management system 102 stores the plurality of tasks in the task queue, where each particular task includes a precondition defining activation logic, a substance defining execution logic, and a postcondition defining subsequent task generation logic.

The pre-conditions 114 define activation logic that determines when a task 104 becomes unblocked for execution. The pre-conditions 114 may include simple temporal conditions, state-dependent conditions based on completion of other tasks, or complex natural language conditions that require evaluation by language models or human participants. The task management system 102 evaluates the activation logic to determine that the particular task is unblocked for execution. The pre-conditions 114 enable tasks to remain dormant until specific real-world conditions are met, allowing for efficient resource utilization and responsive task orchestration.

The execution method 112 defines how a task 104 performs its designated work. The available execution methods 116 provide multiple approaches for task execution, including the human-in-the-loop method 118, the artificial intelligence model 120, and the rule-based computer program 122. The task management system 102 selects, from a group of execution methods, a particular execution method to execute the execution logic of the particular task. The human-in-the-loop method 118 enables human participants to execute tasks that require human judgment, creativity, or domain expertise. The artificial intelligence model 120 provides language-model-based agents and other AI systems for tasks requiring natural language processing, code generation, or complex reasoning. The rule-based computer program 122 implements deterministic scripts and procedures for tasks with well-defined execution patterns.

The task decomposition method 110 enables tasks to break down into subtasks based on execution outcomes and changing requirements. The task decomposition method 110 may operate through deterministic rules, template-based structures, or generative AI analysis. Task templates define reusable task structures for consistent execution patterns across multiple workflow instances associated with the task management system 102. The task templates may be created through artificial intelligence analysis of previously executed task patterns and stored with versioning metadata for template evolution tracking.

The monitor 126 continuously evaluates task states and preconditions across the task queue. The monitor 126 tracks task readiness, manages dependencies, and coordinates the activation of unblocked tasks. The executor 128 implements task execution by routing tasks to appropriate execution methods based on task metadata and system configuration. The task management system 102 receives an execution result of the particular task by the particular execution method. The executor 128 coordinates execution of tasks across multiple execution methods, enabling seamless handoff between human participants, AI agents, and automated systems.

The memory 124 provides shared storage for task data, execution results, and system state information. The memory 124 maintains persistence across extended time periods, allowing tasks to remain dormant for days, weeks, or months while preserving their state and relationships. The memory 124 stores task metadata defining assignment logic for routing tasks to appropriate execution methods. The metadata may include expertise requirements, cost efficiency metrics, risk assessment parameters, access control permissions, and execution method availability constraints.

The goal 130 defines the desired outcome for task execution and provides context for task generation and prioritization decisions. The task management system 102 evaluates execution results and subsequent task generation logic of postconditions to determine new tasks. The evaluation of execution results and subsequent task generation logic may be performed by a language-model-based agent. The task management system 102 adds new tasks to the task queue for subsequent processing, enabling dynamic plan evolution based on real-world execution outcomes.

The network 132 facilitates communication between the task management system 102 and the user devices 108. The network 132 may include local area networks, wide area networks, the Internet, or combinations of different network types. The user devices 108 operated by users 106 provide interfaces for human participation in task execution and system interaction. The interface 134 enables users 106 to interact with the task management system 102 through various modalities including web interfaces, mobile applications, and development environments.

The integrated development environment 136 provides specialized tooling for software development tasks and technical workflows. The task management system 102 integrates with Visual Studio Code through an extension for developer interaction, enabling seamless incorporation of task management capabilities into existing development workflows. The integrated development environment 136 may display task status, provide interfaces for task execution, and enable users 106 to create, modify, and monitor tasks within familiar development contexts.

Tasks within the task management system 102 may include priorities for execution relative to other tasks in the plurality of tasks. The task management system 102 may select particular tasks from among the plurality of tasks based at least in part on the priority. Priority-based selection enables the system to handle multiple concurrent tasks while ensuring that time-sensitive or high-importance work receives appropriate attention. The priority system may incorporate dynamic factors such as deadline proximity, resource availability, and dependency relationships.

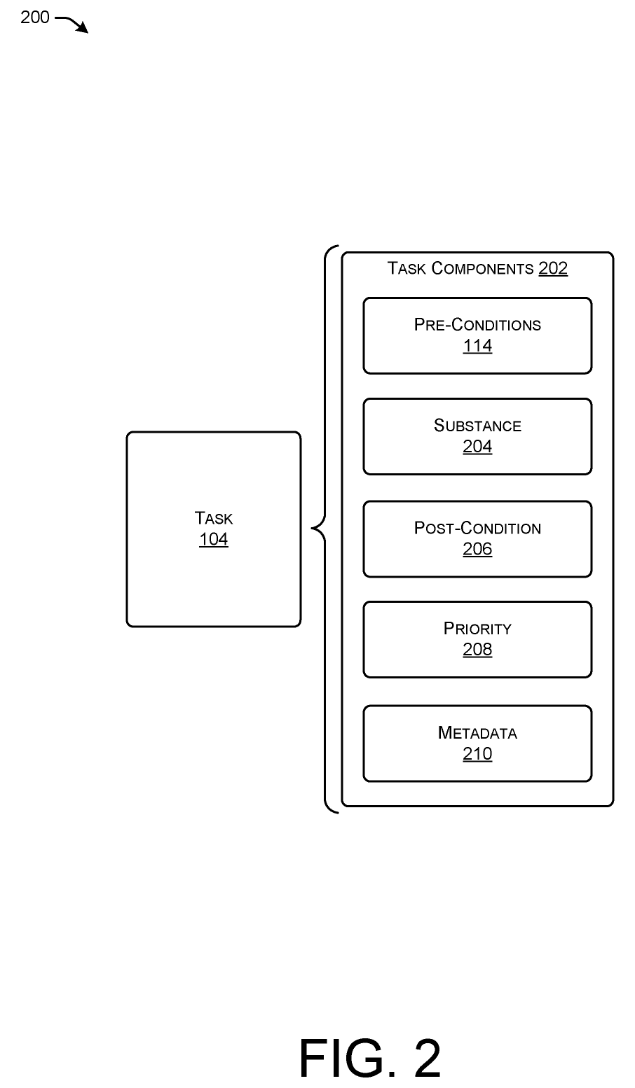

FIG. 2 illustrates a component diagram 200 showing task components 202 associated with a task 104.

The component diagram 200 demonstrates the internal structure of the task 104 through various task components 202 that enable dynamic task behavior and autonomous operation. The task components 202 include pre-conditions 114, which define activation logic for determining when the task 104 becomes ready for execution. The pre-conditions 114 may include logical conditions that evaluate system state, such as time-based triggers or dependency requirements. In some cases, the pre-conditions 114 may include natural language conditions that delegate decision-making to language models or human participants for more complex evaluation scenarios.

The task components 202 also include a substance 204, which defines the execution logic of the task 104. The substance 204 specifies how the task 104 performs its designated function when activated. The substance 204 may comprise executable scripts, such as Python programs or system commands. Alternatively, the substance 204 may include questions or prompts directed to human participants for manual execution. In other embodiments, the substance 204 may delegate execution to artificial intelligence models for automated processing and decision-making.

A post-condition 206 is included within the task components 202 and defines subsequent task generation logic that determines what happens after the task 104 completes execution. The post-condition 206 evaluates the execution results from the substance 204 and generates new tasks based on the outcomes. The post-condition 206 may utilize deterministic rules that create predefined follow-up tasks. In some cases, the post-condition 206 may employ language model-based evaluation to dynamically generate contextually appropriate new tasks. The post-condition 206 may also enable human participants to define subsequent tasks based on execution outcomes, providing flexibility in task evolution.

The task components 202 further include a priority 208 for determining execution order relative to other tasks within the task management system. The priority 208 enables the system to select which tasks to execute when multiple tasks have satisfied pre-conditions 114. The priority 208 may be assigned as numerical values, with higher values indicating greater urgency or importance. The priority 208 may also incorporate dynamic factors such as resource availability, deadline proximity, or dependency relationships with other tasks.

Additionally, metadata 210 is included within the task components 202 for defining task routing and access control parameters. The metadata 210 specifies which execution methods are appropriate for the task 104 based on factors such as required expertise, cost efficiency, and risk assessment. The metadata 210 may include assigned user information, access group permissions, and task type classifications that enable the system to route tasks to suitable execution methods. The metadata 210 may also define security constraints and authorization requirements for task execution.

The task components 202 work together to create autonomous task entities that can evaluate their own readiness, execute their designated functions, and generate follow-up work based on outcomes. The pre-conditions 114 ensure tasks remain dormant until appropriate conditions are met, while the substance 204 provides flexible execution capabilities across different actor types. The post-condition 206 enables dynamic plan evolution through intelligent task generation, and the priority 208 facilitates efficient resource allocation. The metadata 210 ensures proper task routing and maintains security boundaries throughout the execution process.

The task components 202 are embedded within the task 104 as integral structural elements that define the task's autonomous behavior and execution characteristics. The embedding of task components 202 within the task 104 creates a self-contained unit where each component operates as part of a cohesive task architecture. The pre-conditions 114 are embedded as executable logic that the task 104 can evaluate independently to determine its own readiness state. This embedded activation logic allows the task 104 to autonomously assess whether its execution prerequisites have been satisfied without requiring external coordination.

The substance 204 is embedded within the task 104 as the core execution payload that defines the specific work to be performed. The embedded substance 204 may contain references to external resources, executable code, or interaction protocols that the task 104 uses to accomplish its designated function. The embedding approach allows the task 104 to carry its own execution instructions, making it portable across different execution contexts while maintaining consistent behavior.

The post-condition 206 is embedded as generative logic that enables the task 104 to produce new tasks based on its execution outcomes. This embedded task generation capability allows the task 104 to extend the workflow dynamically by creating follow-up tasks that respond to real-world execution results. The embedded post-condition 206 may include template definitions, rule sets, or AI-driven generation logic that the task 104 uses to spawn additional work items.

The priority 208 and metadata 210 are embedded as configuration parameters that influence how the task 104 interacts with the broader task management system 102. The embedded priority 208 enables the task 104 to communicate its relative importance for execution scheduling, while the embedded metadata 210 provides routing and access control information that guides task assignment decisions. These embedded components allow the task 104 to participate in system-level coordination while maintaining its autonomous characteristics.

The embedded nature of task components 202 within the task 104 enables distributed intelligence where each task carries the logic needed for its own lifecycle management. This embedding approach eliminates the need for centralized task orchestration by allowing tasks to self-manage their activation, execution, and follow-up task generation. The task 104 becomes a self-sufficient entity that can operate independently while contributing to larger workflow objectives through its embedded behavioral components.

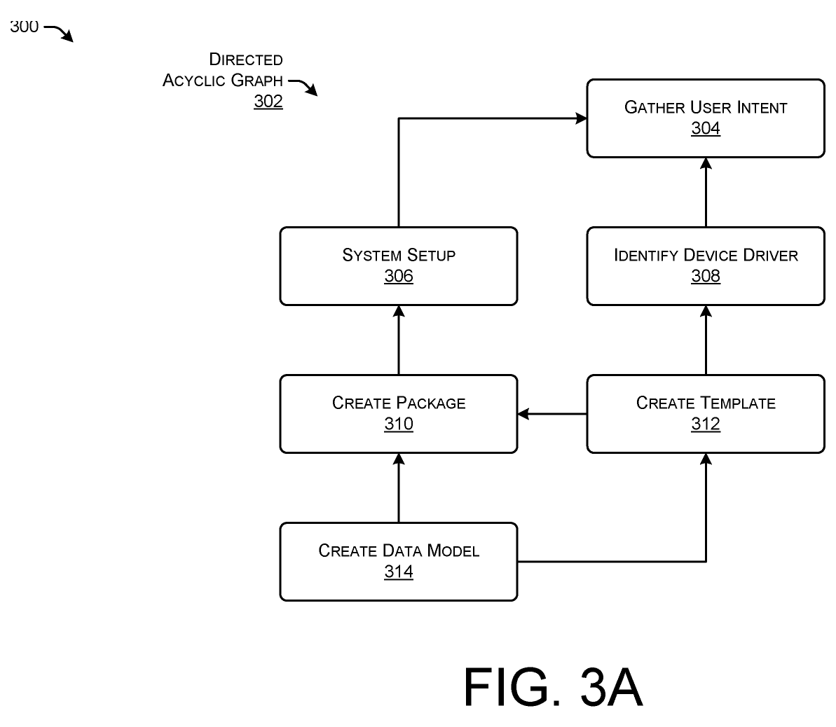

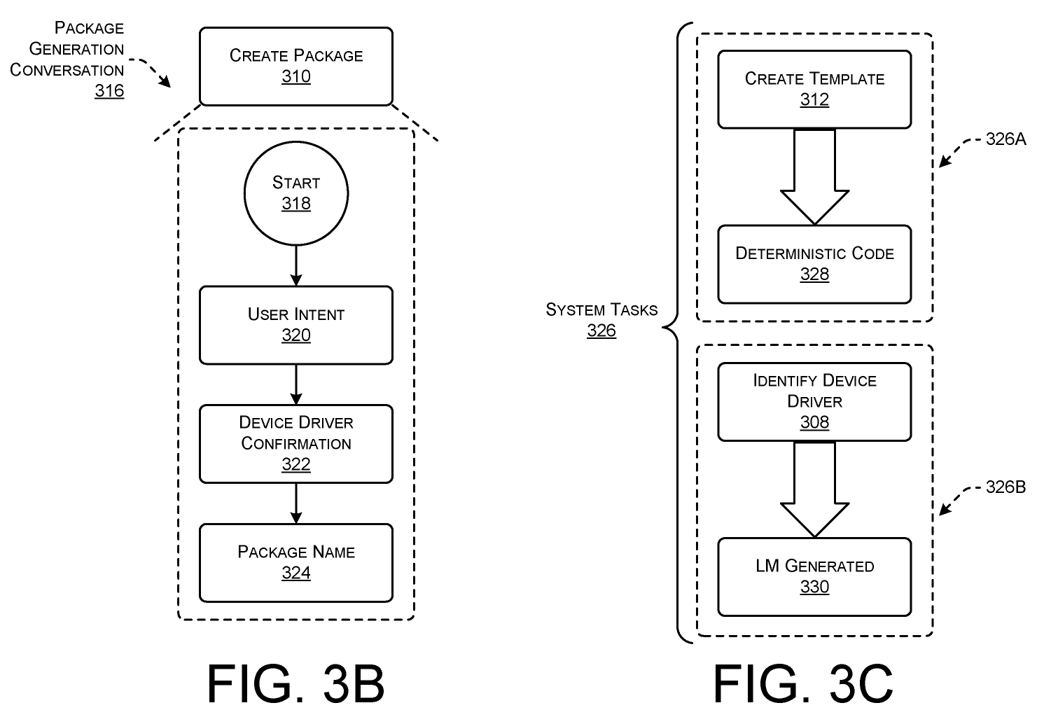

FIG. 3A illustrates a graph diagram 300 showing a directed acyclic graph 302 with interconnected tasks including gather user intent 304, system setup 306, identify device driver 308, create package 310, create template 312, and create data model 314.

The directed acyclic graph 302 represents the structural relationships and dependencies between various tasks within the task management framework 100. A gather user intent 304 task serves as a foundational element that collects requirements and specifications from users 106 to inform subsequent task execution. The gather user intent 304 task may receive input from multiple upstream tasks to establish the overall objectives for the workflow.

A system setup 306 task handles the initialization and configuration of the execution environment needed for task processing. The system setup 306 task connects to the gather user intent 304 task, illustrating that system configuration may depend on user-specified requirements. An identify device driver 308 task determines the appropriate device drivers or interfaces needed for the specific workflow context. The identify device driver 308 task also connects to the gather user intent 304 task, showing that driver selection may be influenced by user intent information.

A create package 310 task generates software packages or deliverables based on the established requirements and system configuration. The create package 310 task receives input from the system setup 306 task, establishing a dependency relationship where package creation may rely on proper system initialization. A create template 312 task develops reusable templates or patterns that can be applied across multiple workflow instances. The create template 312 task connects to both the identify device driver 308 task and the create package 310 task, illustrating that template creation may incorporate both driver-specific information and package requirements.

A create data model 314 task establishes data structures and schemas needed for the workflow execution. The create data model 314 task connects to both the create package 310 task and the create template 312 task, showing that data model creation may depend on both package specifications and template definitions. The directed acyclic graph 302 structure ensures that task dependencies are maintained without circular references, enabling proper execution ordering within the task management system 102.

FIGS. 3B and 3C illustrate flowcharts depicting task decomposition and execution processes, showing how tasks break down into subtasks and coordinate execution across different methods.

FIG. 3B demonstrates a create package 310 process that begins with a package generation conversation 316. The package generation conversation 316 represents an interactive dialogue between the task management system 102 and users 106 to establish package requirements and specifications. A start step 318 initiates the package generation workflow and establishes the initial context for subsequent processing steps.

A user intent step 320 captures specific requirements, preferences, and objectives from users 106 regarding the package to be created. The user intent step 320 may involve presenting questions or prompts through the interface 134 to gather detailed information about the desired package characteristics. A device driver confirmation step 322 validates and confirms the appropriate device drivers or interfaces to be incorporated into the package. The device driver confirmation step 322 may present options to users 106 and receive confirmation of the selected drivers.

A package name step 324 establishes the naming convention and identification parameters for the generated package. The package name step 324 may involve user input through the integrated development environment 136 to specify package names, versions, and other identifying metadata 210.

FIG. 3C depicts system tasks 326 that are divided into two distinct processing groups. A first task group 326A includes a create template 312 step that leads to a deterministic code step 328. The deterministic code step 328 represents rule-based processing that follows predefined logic patterns without requiring artificial intelligence model 120 intervention. The deterministic code step 328 may execute scripted operations or apply established algorithms to generate template components.

A second task group 326B includes an identify device driver 308 step that leads to an LM generated step 330. The LM generated step 330 represents processing performed by language model-based artificial intelligence agents that can analyze context and generate appropriate responses or code artifacts. The LM generated step 330 may utilize the artificial intelligence model 120 to perform complex analysis and generation tasks that require contextual understanding.

The system tasks 326 demonstrate how the task management system 102 can coordinate different execution methods within the same workflow. The first task group 326A and second task group 326B may execute in parallel when their preconditions 114 are satisfied, enabling efficient resource utilization across the available execution methods 116. The decomposition patterns shown in FIGS. 3B and 3C illustrate how complex workflows can be broken down into manageable components that can be executed by appropriate methods, whether human-in-the-loop method 118, artificial intelligence model 120, or rule-based computer program 122.

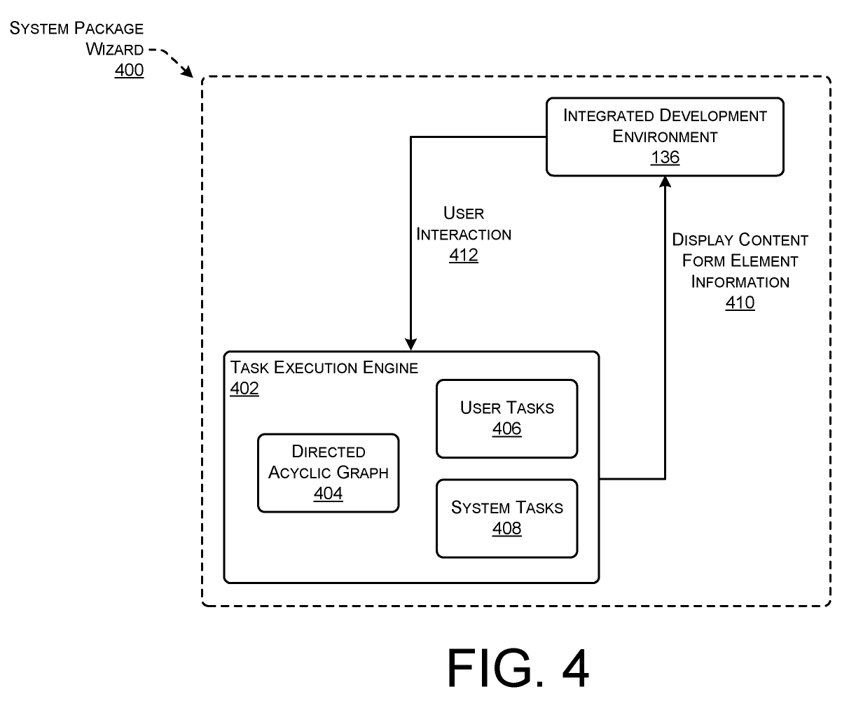

FIG. 4 illustrates a system package wizard 400 that includes multiple interconnected components. The system package wizard 400 comprises a task execution engine 402 that contains a directed acyclic graph 404, user tasks 406, and system tasks 408. The task execution engine 402 receives user interaction 412 and communicates with an integrated development environment 136. The task execution engine 402 provides display content form element information 410 to the integrated development environment 136. The directed acyclic graph 404 maintains the relationships and dependencies between the user tasks 406 and system tasks 408 within the task execution engine 402. The user interaction 412 flows from the integrated development environment 136 to the task execution engine 402, while the display content form element information 410 flows from the task execution engine 402 back to the integrated development environment 136.

The system package wizard 400 operates as a comprehensive task orchestration platform that coordinates complex workflows through the task execution engine 402. The task execution engine 402 serves as the central processing component that manages task execution, maintains task ordering, and facilitates communication between different system layers. The task execution engine 402 processes incoming user interaction 412 from the integrated development environment 136 and generates appropriate responses in the form of display content form element information 410.

The directed acyclic graph 404 within the task execution engine 402 provides a structured representation of task dependencies and execution order. The directed acyclic graph 404 ensures that tasks are executed in the correct sequence by maintaining relationships between the user tasks 406 and system tasks 408. The directed acyclic graph 404 prevents circular dependencies and enables efficient task scheduling by providing a clear hierarchical structure for task execution.

The user tasks 406 represent operations that require human interaction or input through the integrated development environment 136. The user tasks 406 may include configuration dialogs, confirmation steps, or input gathering operations that necessitate user participation. The task execution engine 402 routes the user tasks 406 to the integrated development environment 136 through the display content form element information 410, enabling users to interact with the system and provide necessary inputs.

The system tasks 408 encompass automated operations that can be executed without direct user intervention. The system tasks 408 may include code generation, template creation, validation processes, or other programmatic operations. The task execution engine 402 processes the system tasks 408 internally, utilizing available execution methods such as artificial intelligence models, rule-based systems, or deterministic algorithms.

The user interaction 412 represents the communication pathway through which users provide input, make selections, or respond to prompts generated by the system package wizard 400. The user interaction 412 flows from the integrated development environment 136 to the task execution engine 402, carrying user responses, configuration choices, and other input data. The task execution engine 402 processes the user interaction 412 to determine subsequent task execution steps and update the directed acyclic graph 404 accordingly.

The display content form element information 410 comprises the data and interface elements that the task execution engine 402 sends to the integrated development environment 136 for presentation to users. The display content form element information 410 may include form fields, dialog boxes, progress indicators, confirmation messages, and other user interface components. The task execution engine 402 generates the display content form element information 410 based on the current state of the user tasks 406 and the requirements of the directed acyclic graph 404.

The task execution engine 402 coordinates the flow between user-facing and system-level operations by managing the transition between the user tasks 406 and system tasks 408. When a user task 406 is completed through user interaction 412, the task execution engine 402 may trigger one or more system tasks 408 based on the dependencies defined in the directed acyclic graph 404. Conversely, when system tasks 408 complete execution, the task execution engine 402 may generate new user tasks 406 that require additional user input or confirmation.

The system package wizard 400 maintains task persistence and state management through the task execution engine 402, enabling long-running workflows that may span extended time periods. The task execution engine 402 preserves the state of both user tasks 406 and system tasks 408, allowing workflows to be paused, resumed, or modified as needed. The directed acyclic graph 404 supports dynamic task insertion and dependency modification, enabling the system package wizard 400 to adapt to changing requirements and evolving project needs.

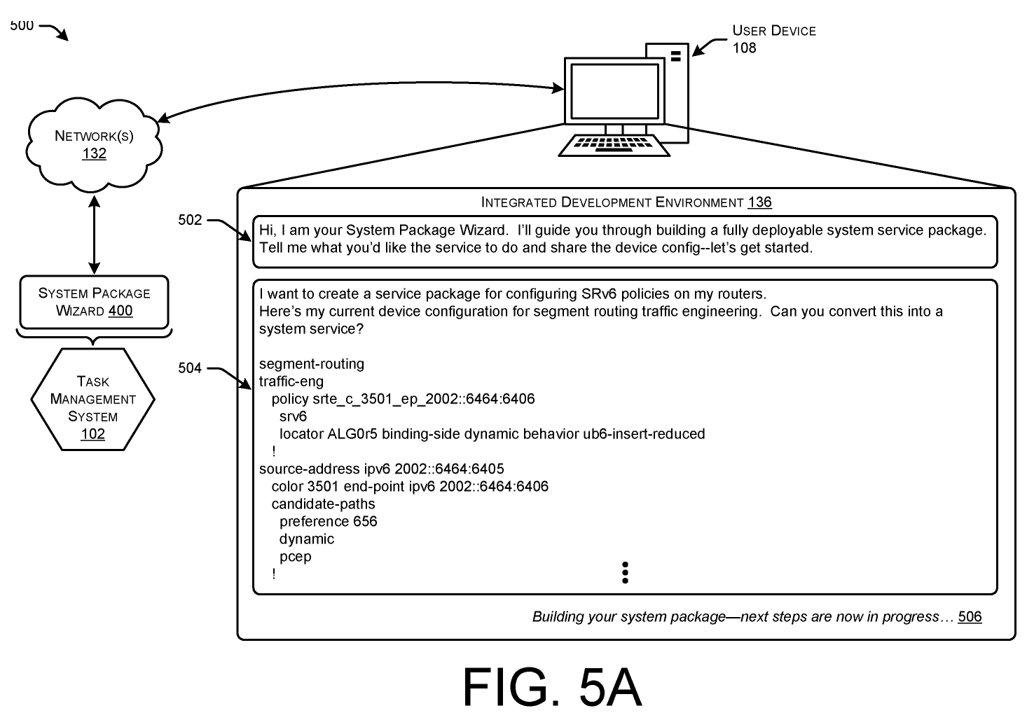

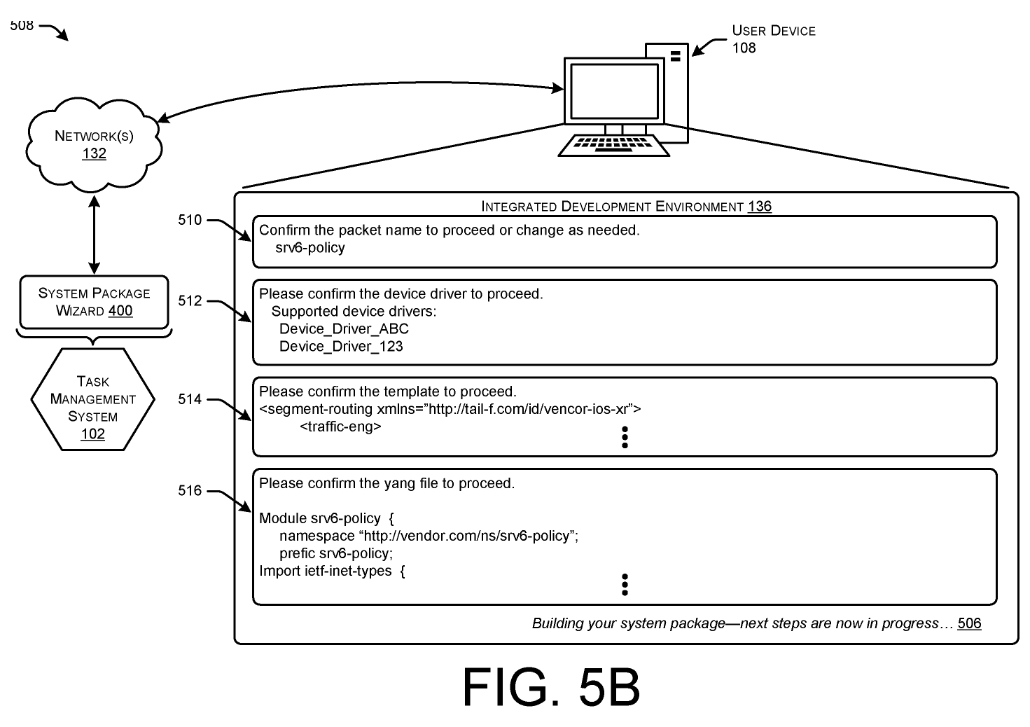

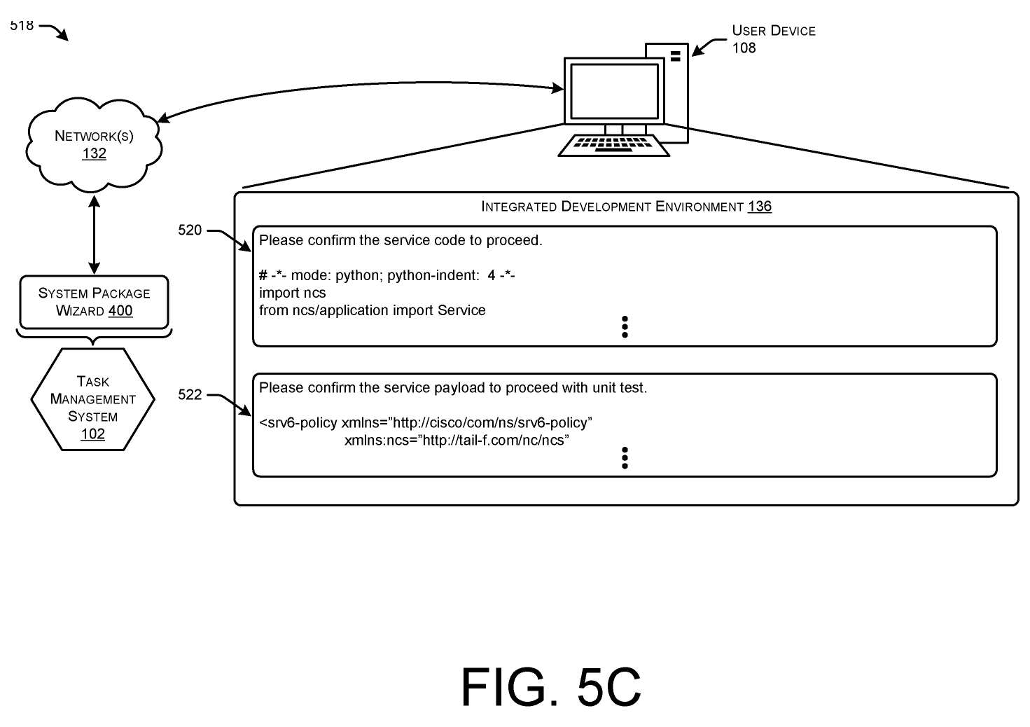

FIG. 5A illustrates a system architecture 500 showing interactions between various components of a task management system. The system architecture 500 includes a task management system 102 connected to a network 132. A user device 108 is also connected to the network 132, and includes an integrated development environment 136. The integrated development environment 136 displays a system package wizard 400 interface that facilitates interaction with the task management system 102. The system package wizard 400 presents a wizard interface 502 that includes a configuration dialog 504 for receiving user input regarding system service package configuration. The configuration dialog 504 displays device configuration information for segment routing traffic engineering. A progress indicator 506 is shown at the bottom of the interface indicating the status of building the system package.

The system architecture 500 demonstrates how tasks within the task management system 102 may manifest as interactive user interface elements through the integrated development environment 136. The wizard interface 502 provides a structured approach for users to interact with the underlying task management framework, where each user interaction may correspond to task execution or task generation within the system. The configuration dialog 504 serves as a mechanism for gathering user input that may be processed by human-in-the-loop execution methods within the task management system 102. The progress indicator 506 provides real-time feedback on task execution status, allowing users to monitor the progression of tasks as the system processes them according to their preconditions and priorities.

FIG. 5B illustrates a system diagram showing interactions between components of an integrated development environment system. The system includes a task management system 102 connected to a network 132 and a user device 108. The integrated development environment 136 is displayed on the user device 108, and interfaces with a system package wizard 400. The integrated development environment 136 displays multiple confirmation interfaces arranged vertically. A packet confirmation interface 510 allows confirmation of packet names. A driver confirmation interface 512 displays supported device drivers for confirmation. A template confirmation interface 514 enables confirmation of template information. A yang file confirmation interface 516 permits confirmation of yang file details.

A communication path 508 connects the network 132 to the user device 108. The interfaces are arranged to show a progression of confirmation steps within the integrated development environment 136, with each interface providing specific configuration options related to package development.

The communication path 508 enables bidirectional data flow between the task management system 102 and the user device 108, facilitating the execution of tasks that require human participation. Each confirmation interface represents a specific task that may be executed through human-in-the-loop methods, where user confirmation or input becomes part of the task execution process. The packet confirmation interface 510 may correspond to tasks related to package naming and identification, while the driver confirmation interface 512 may relate to tasks involving device driver selection and validation. The template confirmation interface 514 and yang file confirmation interface 516 represent tasks associated with template generation and data model validation respectively.

FIG. 5C illustrates a system diagram showing communication between components of an integrated development environment. The system includes a task management system 102 connected to a network 132. A system package wizard 400 interfaces with the network 132. A user device 108 connects to an integrated development environment 136. A communication path 518 extends between the network 132 and the user device 108. The integrated development environment 136 includes a service code interface 520 displaying code confirmation information and a service payload interface 522 showing payload confirmation details. The service code interface 520 and service payload interface 522 provide areas for displaying and confirming different aspects of service-related information within the integrated development environment 136.

The communication path 518 facilitates the transmission of task execution results and new task generation between the task management system 102 and the integrated development environment 136. The service code interface 520 may present the results of tasks executed by artificial intelligence agents or rule-based computer programs, particularly those involving code generation or template creation. The service payload interface 522 may display the outcomes of tasks related to service configuration and payload definition. These interfaces demonstrate how the postcondition logic of executed tasks may generate new user-facing tasks that require confirmation or additional input, creating a dynamic workflow where task execution results directly influence the user interface presentation and subsequent task generation within the system.

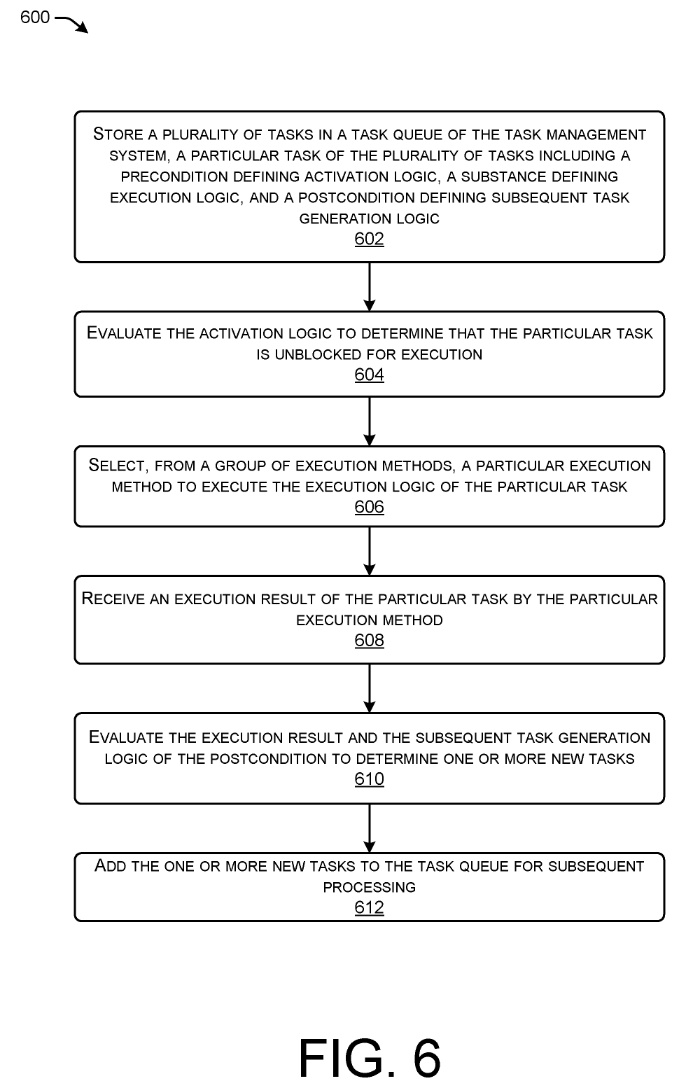

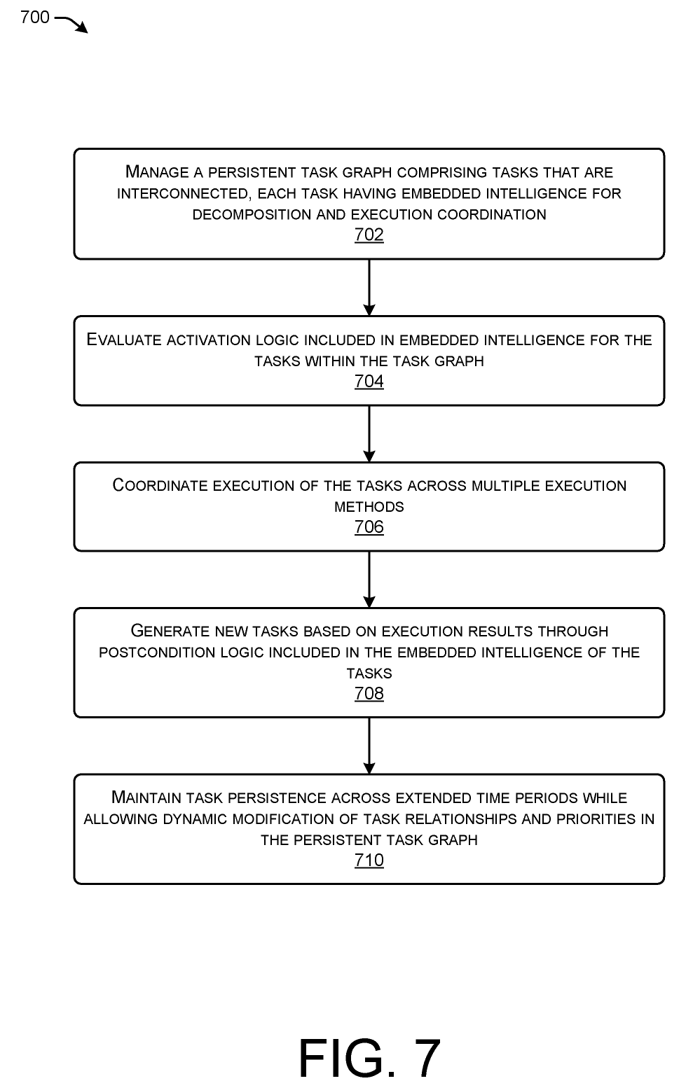

FIGS. 6 and 7 illustrate flow diagrams of example methods 600 and 700 that illustrate aspects of the functions performed at least partly by the devices described in FIGS. 1-5, such as the task management system. The logical operations described herein with respect to FIGS. 6 and 7 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 6 and 7 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 600 and/or 700 may be performed by a device and/or a system of devices that includes one or more processors and one or more non-transitory computer-readable media storing computer-executable instructions that, when executed by the one or more processors, cause the one or more processors to perform operations of methods 600 and/or 700.

FIG. 6 illustrates a flowchart of a method 600 for task management that involves storing tasks in a task queue, evaluating activation logic, selecting execution methods, receiving execution results, and generating new tasks based on postcondition logic.

At 602, the task management system 102 may store a plurality of tasks in a task queue of the task management system, a particular task of the plurality of tasks including a precondition defining activation logic, a substance defining execution logic, and a postcondition defining subsequent task generation logic. The task queue may function as a centralized repository where tasks await processing based on their readiness for execution. Each task stored in the task queue may contain structured components that enable autonomous operation within the adaptive framework. The precondition component may define logical conditions that must be satisfied before task execution can commence, such as time-based triggers, state-dependent conditions, or complex natural language conditions evaluated by language models. The substance component may specify the actual work to be performed, which may range from simple script execution to human interaction requests or artificial intelligence processing tasks. The postcondition component may contain logic for generating subsequent tasks based on execution outcomes, enabling dynamic workflow evolution.

At 604, the task management system 102 may evaluate the activation logic to determine that the particular task is unblocked for execution. The evaluation process may involve continuous monitoring of task preconditions across the entire task queue to identify tasks that have become ready for execution. The activation logic evaluation may be performed dynamically, allowing the system to respond to changing conditions in real-time. The task management system 102 may assess simple boolean conditions, complex state dependencies, or delegate evaluation decisions to artificial intelligence agents or human participants when natural language conditions are involved. Once a task's preconditions are satisfied, the task may transition from a dormant state to an active state, making the task eligible for execution scheduling.

At 606, the task management system 102 may select, from a group of execution methods, a particular execution method to execute the execution logic of the particular task. The group of execution methods may include an artificial intelligence agent, a human participant, and a rule-based computer program. The selection process may be guided by metadata included within the task that defines assignment logic for routing the particular task to an appropriate execution method. The metadata may specify expertise requirements, cost efficiency metrics, and risk assessment parameters that influence the routing decision. The task management system 102 may determine that the particular execution method is the appropriate execution method based on capability matching, availability constraints, and optimization criteria. The selection may also consider access control permissions and execution method availability constraints for task assignment optimization.

At 608, the task management system 102 may receive an execution result of the particular task by the particular execution method. The execution result may contain output data, status information, and contextual details about the task completion process. The execution result may vary in format and content depending on the type of execution method used, with artificial intelligence agents providing structured data outputs, human participants providing interactive responses, and rule-based computer programs delivering deterministic computational results. The task management system 102 may capture both successful completion results and failure conditions, enabling comprehensive handling of various execution outcomes.

At 610, the task management system 102 may evaluate the execution result and the subsequent task generation logic of the postcondition to determine one or more new tasks. The evaluation process may be performed by a language-model-based agent that analyzes the execution outcome and formulates appropriate follow-up actions. The determination of the one or more new tasks may utilize task templates that define reusable task structures for consistent execution patterns across multiple workflow instances associated with the task management system 102. The task templates may be created through artificial intelligence analysis of previously executed task patterns and stored with versioning metadata for template evolution tracking. The postcondition logic may generate zero, one, or multiple new tasks depending on the execution result, enabling flexible workflow branching and adaptation.

At 612, the task management system 102 may add one or more new tasks to the task queue for subsequent processing. The addition process may involve inserting one or more new tasks into the centralized task repository where the one or more new tasks become subject to the same evaluation and execution cycle as other tasks in the queue. The one or more new tasks may include their own preconditions, substance, and postconditions, allowing for continued workflow evolution. The task management system 102 may also consider task priorities when adding new tasks, where the particular task may include a priority for execution relative to the plurality of tasks, and the task management system 102 may select tasks from among the plurality of tasks based at least in part on the priority.

The method 600 may implement an adaptive task management approach through the cyclical execution of these steps, creating a self-sustaining workflow system that evolves based on execution outcomes. The interconnected nature of the steps enables tasks to spawn additional tasks dynamically, supporting complex, long-running processes that adapt to changing requirements and conditions. The method 600 may support persistent task graphs that maintain task relationships across extended time periods while allowing dynamic modification of task dependencies and execution priorities.

FIG. 7 illustrates a flowchart of a method for managing tasks that involves managing a persistent task graph with interconnected tasks, evaluating activation logic, coordinating execution across multiple methods, and maintaining task persistence across extended time periods.

At 702, the task management system 102 may manage a persistent task graph comprising tasks that are interconnected, each task having embedded intelligence for decomposition and execution coordination. The persistent task graph represents a dynamic structure where tasks maintain relationships and dependencies that persist across extended time periods. The embedded intelligence within each task enables autonomous decision-making regarding task decomposition and coordination without relying on centralized control mechanisms. The interconnected nature of the tasks allows for complex workflow patterns where task execution outcomes influence subsequent task activation and generation.

The embedded intelligence may include metadata defining expertise requirements, cost efficiency metrics, and risk assessment parameters for task routing decisions. The metadata may further define access control permissions and execution method availability constraints for task assignment optimization. The persistent task graph structure enables tasks to remain dormant for extended periods while maintaining their relationships and activation conditions.

At 704, the task management system 102 may evaluate activation logic included in embedded intelligence for the tasks within the task graph. The activation logic determines when tasks become ready for execution based on dynamic conditions and dependencies. The evaluation process continuously monitors task preconditions to identify tasks that have become unblocked and available for processing. The activation logic may include time-based conditions, state-dependent conditions, or complex natural language conditions that require evaluation by language models or human participants.

The evaluation of activation logic enables opportunistic task execution where tasks activate automatically when their conditions are satisfied. The dynamic evaluation process allows for flexible workflow execution that adapts to changing conditions and real-world constraints. The activation logic evaluation may occur continuously or at specified intervals to maintain system responsiveness.

At 706, the task management system 102 may coordinate execution of the tasks across multiple execution methods. The coordination process routes individual tasks to appropriate execution methods based on task characteristics and execution method capabilities. The multiple execution methods may include artificial intelligence agents, human participants, and rule-based computer programs that provide different execution capabilities for various task types.

The coordination process may utilize task metadata to determine optimal execution method assignment based on factors such as task complexity, execution cost, and required expertise. The execution coordination enables parallel processing of multiple tasks while maintaining proper sequencing and dependency management. The coordination mechanism may dynamically adjust task assignments based on execution method availability and performance characteristics.

At 708, the task management system 102 may generate new tasks based on execution results through postcondition logic included in the embedded intelligence of the tasks. The postcondition logic analyzes task execution outcomes to determine appropriate follow-up actions and task generation requirements. The one or more new tasks generation process enables adaptive workflow evolution where task execution results influence subsequent workflow structure and content.

The one or more new tasks generation may utilize task templates that define reusable task structures for consistent execution patterns across multiple workflow instances. The task templates may be created through artificial intelligence analysis of previously executed task patterns and stored with versioning metadata for template evolution tracking. The postcondition logic may generate tasks dynamically based on execution outcomes or utilize predetermined task generation patterns for predictable workflow scenarios.

At 710, the task management system 102 may maintain task persistence across extended time periods while allowing dynamic modification of task relationships and priorities in the persistent task graph. The persistence mechanism enables long-running workflows that span days, weeks, or months while preserving task state and relationships. The dynamic modification capability allows for real-time adjustments to task priorities, dependencies, and relationships based on changing requirements and conditions.

The task persistence functionality enables workflow continuity across system restarts and extended dormant periods. The dynamic modification capability may include priority adjustments based on changing business requirements, dependency modifications based on task execution outcomes, and relationship updates based on new task additions. The persistent task graph structure supports workflow evolution while maintaining historical context and execution state information.

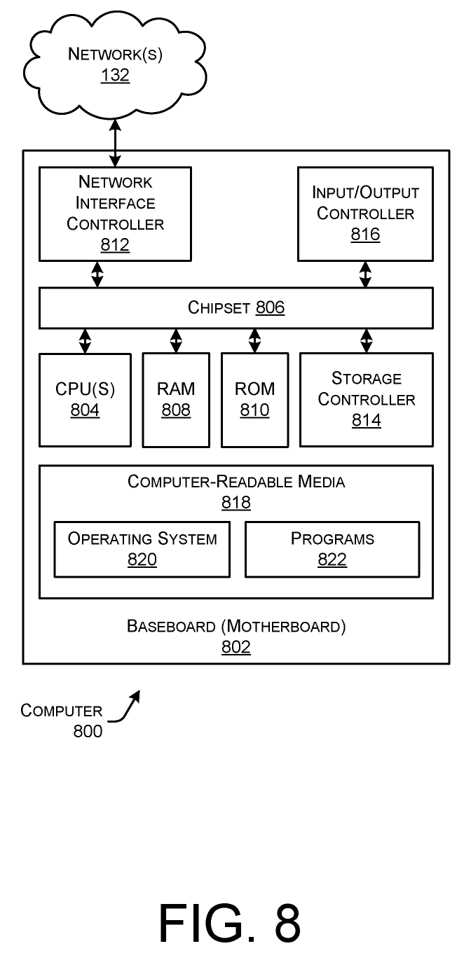

FIG. 8 shows an example computer architecture for a device capable of executing program components for implementing the functionality described above. The computer architecture shown in FIG. 8 illustrates any type of computer 800, such as a conventional server computer, workstation, desktop computer, laptop, tablet, network appliance, e-reader, smartphone, or other computing device, and can be utilized to execute any of the software components presented herein. The computer 800 may, in some examples, correspond to a user device 108, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 800 includes a baseboard 802, or “motherboard,” which is a printed circuit board to which a multitude of components or devices can be connected by way of a system bus or other electrical communication paths. In one illustrative configuration, one or more central processing units (or CPUs 804) operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 132. The chipset 806 can include functionality for providing network connectivity through a NIC 812, such as a gigabit Ethernet adapter. The NIC 812 is capable of connecting the computer 800 to other computing devices over the network 132. It should be appreciated that multiple NICs 812 can be present in the computer 800, connecting the computer to other types of networks and remote computer systems.

The computer 800 can be connected to a storage device 818 that provides non-volatile storage for the computer. The storage device 818 can store an operating system 820, programs 822, and data, which have been described in greater detail herein. The storage device 818 can be connected to the computer 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computer 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 818 by detecting the physical states or characteristics of one or more particular locations within the physical storage units.

In addition to the mass storage device 818 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by the task management system 102, and or any components included therein, may be supported by one or more devices similar to computer 800. Stated otherwise, some or all of the operations performed by task management system 102, and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computer 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computer 800.

In one embodiment, the storage device 818 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7. The computer 800 can also include computer-readable storage media having instructions stored thereupon for performing any of the other computer-implemented operations described herein.

The computer 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 800 might not include all of the components shown in FIGS. 1-7, can include other components that are not explicitly shown in FIG. 8, or might utilize an architecture completely different than that shown in FIG. 8.

As described herein, the computer 800 may comprise a task management system 102 and/or any other device. The computer 800 may include one or more hardware processors (or CPUs 804) configured to execute one or more stored instructions. The processor(s) may comprise one or more cores. Further, the computer 800 may include one or more network interfaces configured to provide communications between the computer 800 and other devices, such as the communications described herein as being performed by the task management system 102. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 822 may comprise any type of programs or processes to perform the techniques described in this disclosure for generating SNFs using a DSL and/or deploying SNFs to optimized network components.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A task management system, comprising:
one or more processors; and
one or more non-transitory computer-readable media storing computer-executable instructions that, when executed by the one or more processors, cause the one or more processors to perform operations comprising:
storing a plurality of tasks in a task queue of the task management system, a particular task of the plurality of tasks including a precondition defining activation logic, a substance defining execution logic, and a postcondition defining subsequent task generation logic;
evaluating the activation logic to determine that the particular task is unblocked for execution;
selecting, from a group of execution methods, a particular execution method to execute the execution logic of the particular task;
receiving an execution result of the particular task by the particular execution method;
evaluating the execution result and the subsequent task generation logic of the postcondition to determine one or more new tasks; and
adding the one or more new tasks to the task queue for subsequent processing.

2. The task management system of claim 1, wherein the group of execution methods includes:
an artificial intelligence agent;
a human participant; and
a rule-based computer program.

3. The task management system of claim 1, wherein:
the particular task further includes metadata defining assignment logic for routing the particular task to an appropriate execution method of the group of execution methods; and
selecting the particular execution method includes determining that the particular execution method is the appropriate execution method.

4. The task management system of claim 1, wherein:
the particular task further includes a priority of the particular task for execution relative to the plurality of tasks,
the operations further comprising selecting the particular task from among the plurality of tasks based at least in part on the priority.

5. The task management system of claim 1, wherein evaluating the execution result and the subsequent task generation logic of the postcondition to determine the one or more new tasks is performed by a language-model-based agent or a rule-based computer program.

6. The task management system of claim 1, wherein determining the one or more new tasks comprises utilizing task templates that define reusable task structures for consistent execution patterns across multiple workflow instances associated with the task management system.

7. The task management system of claim 6, wherein the task templates are created through artificial intelligence analysis or via rule-based generation of previously executed task patterns and stored with versioning metadata for template evolution tracking.

8. A method for centralized task management, comprising:
storing, at a task management system, a plurality of tasks in a task queue of the task management system, a particular task of the plurality of tasks including a precondition defining activation logic, a substance defining execution logic, and a postcondition defining subsequent task generation logic;
evaluating, at the task management system, the activation logic to determine that the particular task is unblocked for execution;
selecting, by the task management system and from a group of execution methods, a particular execution method to execute the execution logic of the particular task;
receiving, at the task management system, an execution result of the particular task by the particular execution method;
evaluating, at the task management system, the execution result and the subsequent task generation logic of the postcondition to determine one or more new tasks; and
adding the one or more new tasks to the task queue for subsequent processing.

9. The method of claim 8, wherein the group of execution methods includes:
an artificial intelligence agent;
a human participant; and
a rule-based computer program.

10. The method of claim 8, wherein:
the particular task further includes metadata defining assignment logic for routing the particular task to an appropriate execution method of the group of execution methods; and
selecting the particular execution method includes determining that the particular execution method is the appropriate execution method.

11. The method of claim 8, wherein:
the particular task further includes a priority of the particular task for execution relative to the plurality of tasks,
the method further comprising selecting the particular task from among the plurality of tasks based at least in part on the priority.

12. The method of claim 8, wherein evaluating the execution result and the subsequent task generation logic of the postcondition to determine the one or more new tasks is performed by a language-model-based agent or a rule-based computer program.

13. The method of claim 8, wherein determining the one or more new tasks comprises utilizing task templates that define reusable task structures for consistent execution patterns across multiple workflow instances associated with the task management system.

14. The method of claim 13, wherein the task templates are created through artificial intelligence analysis or via rule-based generation of previously executed task patterns and stored with versioning metadata for template evolution tracking.

15. One or more non-transitory computer-readable media storing computer-readable instructions that, when executed by one or more processors, cause a task management system to perform operations comprising:
managing a persistent task graph comprising tasks that are interconnected, each task having embedded intelligence for decomposition and execution coordination;
evaluating activation logic included in embedded intelligence for the tasks within the task graph;
coordinating execution of the tasks across multiple execution methods;
generating new tasks based on execution results through postcondition logic included in the embedded intelligence of the tasks; and
maintaining task persistence across extended time periods while allowing dynamic modification of task relationships and priorities in the persistent task graph.

16. The one or more non-transitory computer-readable media of claim 15, wherein coordinating execution of the tasks comprises routing individual ones of the tasks to one or more of the execution methods based on metadata included in the embedded intelligence, the metadata defining expertise requirements, cost efficiency metrics, and risk assessment parameters.

17. The one or more non-transitory computer-readable media of claim 16, wherein the metadata further defines access control permissions and execution method availability constraints for task assignment optimization.

18. The one or more non-transitory computer-readable media of claim 15, wherein generating the one or more new tasks comprises utilizing task templates that define reusable task structures for consistent execution patterns across multiple workflow instances.

19. The one or more non-transitory computer-readable media of claim 18, wherein the task templates are created through artificial intelligence analysis or via rule-based generation of previously executed task patterns and stored with versioning metadata for template evolution tracking.

20. The one or more non-transitory computer-readable media of claim 15, wherein:
the embedded intelligence further includes priorities usable to determine an execution order of the tasks relative to each other; and
coordinating execution of the tasks across the multiple execution methods includes causing the tasks to be executed according to the execution order.
